(19) United States
(12) Patent Application Publication
(10) Pub. No.: US 2019/0244171 A1
(43) Pub. Date: Aug. 8, 2019

(54) SUPER RETAIL SYSTEM AND METHOD

(71) Applicant: James Pallios, Turlock, CA (US)

(72) Inventor: James Pallios, Turlock, CA (US)

(21) Appl. No.: 16/208,426

(22) Filed: Dec. 3, 2018

Related U.S. Application Data
(60) Provisional application No. 62/593,984, filed on Dec. 3, 2017.

(51) Int. Cl. G06Q 10/08; G06Q 30/06

(52) U.S. Cl. CPC G06Q 10/08355; G06Q 30/0605

(57) ABSTRACT

A system and method for accommodating receipt of environmentally-friendly delivery of all these orders from all these purchasers with a system that helps promote locate physical retailers. A system and method includes delivery infrastructure resource sharing and coordination, single pick order fulfillment options for retailers and organizations participating in the system, and green reward tracking and fulfillment associated with decreased environmental impacts of use of the system and methods.

### CROSS REFERENCE TO RELATED APPLICATIONS

This Application claims the benefit of U.S. Provisional Application 62/593,984 filed on Dec. 3, 2017, the contents of which are hereby expressly incorporated by reference thereto in its entirety for all purposes.

### FIELD OF THE INVENTION

The present invention relates generally to online order fulfilment, and more specifically, but not exclusively, to physical delivery of online orders to multiple purchasers.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Individuals have many options for the purchase of various goods, particularly durable goods. For example, there are many online retail portals which allow a purchaser to select a set of durable goods and specify purchase and delivery options. The purchaser repeats this process for each individual order although some retail portals may offer some shortcuts to the purchaser to allow customizations for frequently used options.

A challenge for the average purchaser is that the various portals may use any of several delivery services which may deliver the ordered goods to the desired address (typically the home). This can mean that packages are delivered at various times throughout the day, and sometimes the evening. It can be difficult for some purchasers to adjust their schedules to be present at estimated delivery times, which can vary widely. When a purchaser is not present, either the goods may be left unattended or held by the delivery service. In either case this offers further inconvenience or risk to the purchaser. Different retail portals offer delivery services from different delivery entities, and not all delivery entities may offer delivery service to all potential delivery addresses for any particular purchaser.

There are times when the purchaser is away from home for extended periods, such as vacation or business travel. During these times, the purchaser may wish to redirect their deliveries to their temporary address.

From a perspective of various “brick and mortar” retailers, they have invested in storage and delivery infrastructure, customer accessibility, and customer convenience that may sometimes appear to be operate at a competitive disadvantage with respect to large online retailers. One disadvantage is that every local retailer may not be able to stock the extremely diverse range of goods desired by the consuming public. One reason can be that the distribution system for local physical retailers can be different from large online retailers. That is, in order for a local retailer to obtain any amount of a type of good, it may need to order goods in quantities that are in excess of those that its set of regular consumers will purchase. This means that consumers and manufacturers can be disadvantaged by a conventional local physical store retail model. The consumer is disadvantaged in that they will have fewer goods to select from and the manufacturer is disadvantaged in that they are not able to get placement in some of these local stores until local consumer demand is high enough.

One seemingly unrelated concern shared by many purchasers are environmental concerns regarding global warming and other potential environmental impacts of various purchasing options. There are fleets of vehicles from various governmental and commercial delivery services crisscrossing all the neighborhoods. Sometimes multiple different vehicles from different make individual deliveries to the same purchaser on the same day or over the same week.

Currently there is no easy and efficient option for a purchaser, or local physical retailer, to address these supply and delivery concerns, including environmental impacts.

### BRIEF SUMMARY OF THE INVENTION

Disclosed is a system and method for accommodating receipt of environmentally-friendly delivery of all these orders from all these purchasers with a system that helps promote locate physical retailers. The following summary of the invention is provided to facilitate an understanding of some of the technical features related to super retail systems and methods, and is not intended to be a full description of the present invention. A full appreciation of the various aspects of the invention can be gained by taking the entire specification, claims, drawings, and abstract as a whole. The present invention is applicable to other super retail and high-traffic locations in addition to grocery stores and the like.

An embodiment of the present invention may include a commercial delivery hub that offers a delivery agency able to accept delivery on behalf of purchasers. This commercial delivery hub preferably includes one or more attributes and characteristics such as offering secure storage for deliveries, accessibility by delivery services, and purchaser access convenience (e.g., extended hours and geographic proximity). For example, a commercial delivery hub may be associated with an existing retail or service operation that is already frequented by many prospective online purchasers. Local grocery stores are one example of such an operation.

A grocery store local to a purchaser may include all these attributes and characteristics. The grocery store may accept delivery and secure storage of all of the deliveries on behalf of the purchaser over a wide window of time. The grocery store may be accessed by many more delivery services than are available to the purchaser, providing the online retailer with a wider range of delivery options to fulfill each purchaser's order. The grocery store often has business hours that are more convenient to the purchaser, such as before or after work. Grocery stores are often located at places that are geographically proximate to many potential purchasers. The grocery store offering this delivery agency is further desirable to the purchaser as the purchaser will be able to shop for any needed or desired non-durable goods and services that are available. A grocery store offering this delivery agency will distinguish itself from those that do not offer this delivery agency which is anticipated to increase business.

An embodiment of the present invention may include may include an ability to coordinate, on behalf of individual purchasers, convenient delivery agencies for home, work, vacation, travel, and other instances. When a purchaser knows their location for a given period, any deliveries may be arranged to be made to a delivery agency convenient to that location at that time.

An embodiment of the present invention may include various mechanisms, transparent to each purchaser, to coordinate among all the delivery services available to the retailers and the delivery agency to reliably and more efficiently route deliveries to the delivery agency for all purchasers that have identified the particular delivery agency. This transparent coordination may be dynamic and respond to just-in-time or other real-time delivery capacity availability for various delivery services on any given day or hour.

An embodiment of the present invention may include an ability of delivery services that are over or under capacity with respect to an individual delivery vehicle to a particular delivery agency.

An embodiment of the present invention may include mechanisms for using and implementing delivery efficiencies that would be unavailable to an unorganized collection of purchasers.

An embodiment of the present invention may include systems and processes that track the improved delivery efficiencies and representing them as some environmental impact metric. The system and process may determine, for each purchaser, individual and aggregated environmental impact metrics which may further enhance the desirability of using convenient delivery agencies. Each person may be provided with their personal environmental impact metrics in various ways to display and encourage use of these delivery agencies.

An embodiment of the present invention may include systems and processes to convert aggregated environmental impact metrics to various rewards, incentives, points, compensation, or other value for the purchaser.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a conventional retail system; and

FIG. 2 illustrates an embodiment of the present invention including an improved retail system.

### DETAILED DESCRIPTION OF THE INVENTION

Embodiments of the present invention provide a system and method for accommodating receipt of environmentally-friendly delivery of all these orders from all these purchasers with a system that helps promote locate physical retailers. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

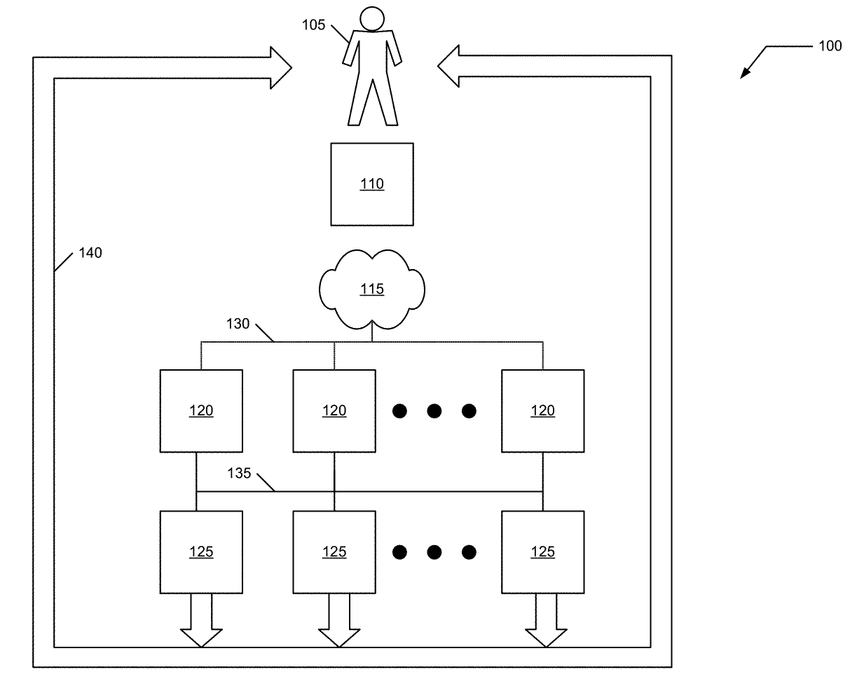

FIG. 1 illustrates a retail system 100 in which a consumer 105 uses a computing system 110 to place on online order for a set of goods through an electronic communication cloud 115 (e.g., the Internet or World-Wide Web) to a wide variety of online retailers 120. Retailers 120, in turn, have commercial relationships with a wide variety of delivery services 125, each of which makes individual deliveries to each user 105. A set of electronic communication pathways 130 exist between cloud 115 and retailers 120. Retailers 120 use commercial delivery routes 135 to make the ordered goods available to delivery services 125. Various consumer delivery routes pathways, such as highways, skyways, waterways, roads, and the like, to place the ordered goods into the hands of user 105.

System 100 not only services user 105, but millions of other users just like user 105. Fleets of delivery vehicles from the myriad of delivery services 125 are all using pathways 140, sometimes making multiple deliveries to user 105 in one day. A consequence of this is that major delivery services 125 crisscross local streets every day: on one day making a delivery to user 105, another day making a delivery to a neighbor of user 105, and on other day perhaps deliveries to both.

System 100 highlights one of the problems addressed by some embodiments of the present invention, that user 105 may not always be physically available to accept a hand-off of their goods from any deliverer from any of delivery services 125, at the schedule of the deliverer.

Another issue that is not readily apparent from the components of system 100 is the composition of delivery services 125. For system 100 to be effective for millions of geographically distributed users 105, delivery services 125 are necessarily constrained by the type of goods that can be delivered in this fashion. For example, any good for delivery by delivery service 125 must be small and light enough to be handled by typically one delivery person in a step van or other vehicle suitable to maneuver a majority of residential streets. To be cost effective to the retailers and users, economies of scale must exist for delivery services 125 which of necessity are a subset of all the various types of commercial delivery services. Well-known user-centric delivery services 120 include organizations such as FedEx, UPS, USPS, DHL, and the like. And as a consequence of this, the types of goods that retailers 120 may offer to users 105 are constrained by the types of goods that delivery services 125 have agreed to transport for their customers (e.g., users and/or retailers). For purposes of this application, these two types of goods are referred to as durable goods and non-durable goods. Durable goods include larger, unwieldy, and/or heavy goods that are not routinely delivered by consumer delivery services 125 (DHL, FedEx, UPS, USPS, and the like) such as appliances, assembled furniture, assembled vehicles, and the like commonly moved/transported by an alternative to delivery services (e.g., common carrier or vertically integrated large trucks). Non-durable goods include smaller, manageable, and/or lighter goods that are routinely delivered by consumer delivery services 125. A third category of goods, grocery and perishable goods, are periodically tested for effectiveness and consumer desirability for home delivery and will be further addressed below but are currently handled outside of system 100.

For many users 105, an area of increasing concern for online shopping relates to environmental impact. Multiple deliveries in one day by delivery services 125 that drive throughout each neighborhood every day making individual geographically dispersed deliveries to all the users may be viewed by some users as having a negative environmental impact.

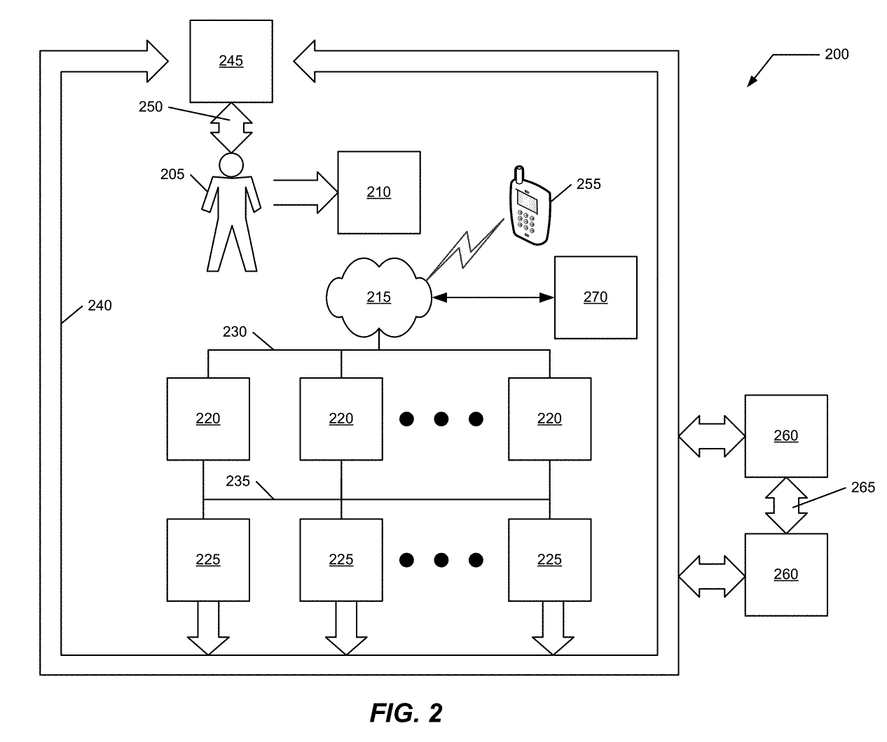

FIG. 2 illustrates an embodiment of the present invention for a machine-implemented super retail system 200 and associated methods. System 200 may appear, upon casual review, to be quite similar to system 100. However, system 200 radically changes the paradigm a user may access when obtaining goods from online sellers and provides different and improved economies of scale and may allow for decreasing and quantifying/tracking environmental impacts of online ordering of goods while providing various mechanisms for local physical retailers to leverage their investments to service the local consumer base.

System 200 includes a user 205 operating a computer platform 210 to identify and purchase various online orders through a cloud communication system 215 that provides electronic communication to a different collection of online retailers 220 that are enabled to use a modified set of delivery services 225. A set of communication channels 230 couple messaging back and forth between user/computer/cloud/retailers as each user 205 searches, reviews, selects, identifies, and purchases of sets of goods from retailers 220.

Once the ordering is completed, retailers 220 use a modified set of commercial delivery routes 235 to transfer ordered goods from retailers 220 to modified delivery services 225 which then may access a modified set of pathways 240 to deliver the ordered sets of goods to a consumer delivery proxy 245. Delivery proxy 245 accepts custodial delivery of the ordered goods on behalf of user 205, the owner. A proxy-user connector 250 may provide several different modalities for transferring physical possession of the ordered goods from delivery proxy 245 to user 205.

An alternative computing platform 255, such as a portable electronic device (e.g., smartphone, PDA, tablet computer, laptop computer, or the like) may be included to allow user 205 to track various status and delivery messages from system 200. In some embodiments, user 205 may access platform 210 in addition to, or in lieu of, alternative platform 255. In other embodiments, platform 255 may serve as primary computer platform 210 for identifying and placing orders as discussed herein and for determining a user's status within system 200.

Some embodiments of the present invention may strategically locate a collection of delivery proxies throughout a geographic region of interest. An embodiment of the present invention may install any particular delivery proxy 245 at a location that is already frequented by many people, including prospective users 205. For example, a grocery store may be a particularly advantageous location into which delivery proxy 245 may be installed, which may be referred to as a super retailer when it includes such a delivery proxy 245.

Locations for major grocery stores (Safeway, Kroger, Albertsons, Ahold, Lucky, Raley's, and the like) are often chosen precisely because they are conveniently located for many people. Installation of delivery proxy 245 at such a location may allow system 200 to offer many advantages over system 100. These advantages may include extended hours (for both accepting orders from delivery services 225 and for transferring physical possession of accepted orders to each user 205), convenient location, and the business which includes delivery proxy 245 may be an establishment that user 205 already periodically frequents for other shopping needs (e.g., groceries or other goods).

When user 205 travels, the travel location may be nearby a different establishment that hosts a different delivery proxy convenient for the travelling user 205. User 205, with advance knowledge of travel plans, may have important deliveries routed to a convenient delivery proxy 245 wherever user 205 finds themselves. That is, when user 205 has a home location and a vacation location, user 205 may authorize deliveries to proxy 245 near home when user 205 is at home and authorize deliveries to a different proxy 245 near the vacation location when user 205 is vacationing.

As noted herein, system 200 may include additional features to further enhance economies of scale and allow system 200 to be a cost-effective solution for both hosts of delivery proxies 245 (e.g., super retailers) and users 205. These features may include the use of modified routes 235, modified delivery services 225, and modified delivery pathways 240, among other features.

While individual online retailers 220 are illustrated as specific discrete organizational units, in practice each online retailer may itself include a collection of geographically distributed warehouses, distribution centers, and various commercial delivery entities, typically different from services 225, that move goods internally and externally. Those external routes from the online retailer organizational unit are included in modified routes 235.

Modified delivery services 225 may be different from delivery services 125 in that many hosts for delivery proxy 245 include an more extensive delivery infrastructure that may accommodate larger delivery vehicles (e.g., 18-wheelers and other larger vehicles with lift gates which may deliver pallets of goods to a loading dock), fork lifts for moving the pallets, and trained personnel to operate the fork lifts and handle the safe and efficient acceptance and storage of these goods. In some embodiments, modified delivery services 225 are a superset of delivery services 125 and may include common carriers, vertically integrated trucking, and other non-consumer commercial delivery options. For most consumers, such infrastructure is unavailable at home or vacation locations, inaccessible to an individual in a case where an individual's work location includes some commercial delivery options, even if it were cost-effective and possible to have the larger vehicles maneuver through the neighborhoods to reach all the locations currently serviced by delivery services 125 of FIG. 1. These delivery services 125 also routinely service potential hosts that may install a delivery proxy 245 so the hosts and users of system 200 have the same availability as system 100 while also allowing for enhancements over system 100 through end-user use of an extended delivery infrastructure.

The possible availability of this delivery and freight handling infrastructure of proxy 245 hosts of system 200 allows for user 205 to access more goods through different delivery services 225 which may enhance the experience of system 200 for user 205. That is, not only are any of the goods available through system 100 available to user 205 in system 200, different delivery services may allow access to additional retailers, distributors, wholesalers, and suppliers which provide more options for goods.

System 200 may further include other organizations 260, such as distributors, warehousers, suppliers, and others business units which may source and/or transport goods. It may be the case that user 205 is not able to directly access or purchase from organizations 260, but one or more other entities in system 200 may have access and allow user 205 to make selections for inclusion in their deliveries to proxy 245.

Organizations 260 may not only access pathways 240, but they may have customized delivery arrangements that they share with one or more other entities. For example, one such customized delivery arrangement 265 is illustrated in FIG. 2 which allows for shared delivery infrastructure sharing between organizations 260. Collectively, these enhanced delivery systems may be referred to as a distribution network for delivery proxy 245.

System 200 may be configured and operated in many different ways, and these configurations may be dynamically adjusted based upon resource availability. Some embodiments of the present invention may perform these adjustments in efforts to optimize delivery time and efficiency. Improved efficiencies for system 200 are already achieved by consolidating deliveries to a single delivery proxy 245. For example, each delivery service 225 having deliveries for any user 205 associated with a specific one delivery proxy 245, may load all these orders into one shipment (on one or more pallets) destined for this specific one delivery proxy 245.

Further efficiencies may be available in system 200 when some part of a shipment by one delivery service is partially or wholly handled by another delivery service. For example, an entity of system 200, a particular delivery service 225 or a particular organizational unit 260, may have a shipment scheduled for delivery proxy 245. That shipment may employ a vehicle having excess capacity for needs of the shipment. Some other delivery service or organizational unit may find it convenient and efficient to deliver a pallet of goods (e.g., also destined for the particular delivery proxy) for inclusion on the vehicle. This is possible with system 200 when using pallets and having enhanced shipping, docking, and goods handling services and equipment at delivery proxy 245.

In some embodiments, because relatively large capacity deliveries are moving to, from, and in-between various individual proxies 245, system 200 may allow user 205 to easily reroute a particular delivery from one delivery proxy to another delivery proxy, even for deliveries received as particular delivery proxy 245.

System 200 may include a computer-implemented supervisory function 270 to coordinate the identification and routing of orders to specific delivery proxies 245, to coordinate various delivery service capacity sharing, and informing each user 205 of various status information concerning their orders. For example, supervisory function 270 may provide various push notifications, for example on device 255, to each user 205 regarding order confirmation, scheduled delivery time, notification of availability of order(s) at particular delivery proxies 245, receipt information, and any other status and informational messaging. Supervisory function 270 may allow a user to set various default locations (e.g., home, work, travel, and default delivery modes (e.g., overnight, 2-day, standard, and the like). This other informational messaging may include some qualitative or quantitative assessment or indication of various environmental impact consequences from choices that user 205 has made with respect to a particular order or a set of orders (including savings costs and reduced some metric of environmental impact through use of the system (e.g., CO2 saved).

System 200 may provide decreased environmental impacts over system 200 because of several features, including multiple orders for multiple users consolidated at a single delivery proxy 245, an availability enhanced delivery efficiencies (for example, sharing vehicle capacity or time-slot capacity). By time-slot capacity, consider two organizational units 260, each having a weekly scheduled shipment for delivery proxy 245: one ships its goods on a Monday and the other ships its goods on a Thursday. When these organizational units are geographically close to each other, supervisor function 270 may coordinate between the two units allowing each organizational unit to have its goods arrive at delivery proxy twice a week instead of once a week. Each unit piggybacks on the other unit's vehicle for alternative shipments. For users and retailers, it is sometimes the case that any delay in obtaining ordered goods may dampen enthusiasm user 205 had for the purchase. The user may not make the order or may find another source when a delay is perceived to be too long. Broadly, for purposes of the present application, a term “cross dock” or “cross docking” refers to a sharing of delivery service infrastructure resource by a retailer, organizational unit, delivery service, and/or a delivery proxy. These shared resources may predominately refer to delivery vehicles (e.g., capacity and schedule) but in some cases may include shared warehousing and shared distribution as well.

Associated with various cross-docking opportunities is an ability for system 200 to employ various single pick options. One potential limitation for local physical retailers is to match commercial quantities (e.g., a case of product X which may include 24 retail units of product X) with a consumer who may desire to purchase just 1 retail unit. In the event of some goods, such as organic foods, probiotics, expensive spices, or other retail product, the local physical store may not be able to provide the customer with a single retail unit because it is unable to accommodate the remaining un-used units of the commercial quantity within a reasonable period of time. System 200 allows single pick throughout all retailers 220 and organizations 260 in system 200 to efficiently make units available in less than commercial wholesale/distributor quantities for retail quantities, including a single retail unit that can be purchased by user 205. In system 200, many embodiments provide for palletized delivery of multiple goods and orders. At any stage, any organization 260, retailer 220, or other supplier/manufacturer that is servicing delivery proxies 245 of system 200, simply add the single unit to the deliver. A more generic description of this single-pick is that a next delivery stop, including intermediate delivery transfer, holding, or distribution, is provided a less-than-commercial quantity that has been divided from an commercial quantity. That is, when a delivery is destined for a delivery proxy 245, the single pick may be a single retail unit. When a delivery is destined for an intermediate delivery station that services two delivery proxies, each having a customer ordering a single retail unit, single pick may include the delivery of two (less than a commercial quantity) of the product an intermediate delivery station that services both delivery proxies 245 associated with these purchasers. The intermediate delivery station may then make an appropriate distribution to the correct pallet, box, or other delivery unit destined for the appropriate specific delivery proxy 245 associated with users 205 ordering those particular retail units. In this way a local physical retailer is able to effectively increase product availability to potential consumers without delays that may seem to be excessive to a user.

Associated with delivery proxy 245 is proxy-user connector 250 that provides for an actual physical transfer of goods from delivery proxy 245 to user 205. Proxy-user connector 250 may include a fulfillment center where single pick orders from a set of organizational units 260 or the enterprise hosting delivery proxy 245 (e.g., a super retail grocery store) are selected for inclusion with orders for user 205. Connector 250 may represent a set of transfer modalities associated with delivery proxy 245 and operational with any fulfillment center such as a pickup desk, service counter, curbside delivery, or actual “last mile” delivery to the location of user 205 on their schedule. “Last mile” may, in some instances, refer generically to connector 250 and encompass many possible mechanisms for providing user 205 with physical possession of their goods. In some cases, the delivery infrastructure of 200 that may be included as part of connector 250 may include ad-hoc delivery solutions (Uber, Lyft, or ad hoc on demand delivery services (e.g., TaskRabbit and the like)), or any other mechanism to transfer physical possession from a custodian delivery proxy to user 205 who owns the goods.

Delivery proxy 245 may, in some embodiments, include outgoing services for user 205 to send packages using some or all of the delivery infrastructure of system 200, particularly using delivery services 225 as they may be more likely to service the delivery location for the packages of user 205.

Some embodiments of the present invention may include an awareness and monitoring of environmental impacts of system 200, sometimes referred to herein as “green delivery” of goods ordered online, from any retailer or supplier of system 200. Supervisory function 270 may measure “single stop multiple package delivery” (inclusive of orders from multiple users 205) versus a more conventional multiple stop single (user) delivery represented by multiple discrete deliveries to individual users at each of their homes. In this regard, delivery proxy 245 servicing multiple users 205 with shared delivery resources and coordinating and monitoring these activities using supervisory function 270 may offer many of these green delivery attributes.

These green delivery attributes may represent quantitated savings to environmental and economic success (particularly over system 100) that may be calculated and logged by supervisory function 270. Each user 205 may have an electronic footprint that includes a history of purchases, “last mile” options, and evolving profiles in system 200. Various defaults for desired options of delivery proxy location, last mile selection, fulfillment options, and the like may be developed for a user to improve usefulness of system 200 for each user 205.

The quantitated savings may, in some circumstances, be determined from historical electronic footprint choices viewed and redistributed by a carbon footprint tracker feature of supervisory function 270.

The carbon footprint tracker feature may include various functions of system 200 to track an efficiency of resource sharing in the delivery and transfer of goods to user 205 by use of system 200, such as each user's share of a CO2 impact of a delivery vehicle that delivers goods for 100 users. For example, 1/100^{th} of the delivery vehicle CO2 emission, including any enhanced efficiency for infrastructure sharing, for delivery to delivery proxy 245 versus the user's contribution from delivery services 125.

The carbon footprint tracker may track each individual user's benefit from system 200 (or an aggregated family metric depending on some options that may be available in some embodiments). The carbon footprint tracker feature may calculate the user's participation in reducing their carbon footprint order by order, delivery by delivery. The carbon footprint tracker may be used to quantify and mitigate the carbon footprint for each user 205. The carbon footprint tracker may bring the entire system as employed by user 205 into a single focus SINGLE SCREEN on device 255 communicating with supervisory function 270, allowing the consumer's profile to grow based on historical transactions BUT profiles and the carbon tracking may be kept in-order to manage and quantify the user's carbon mitigation success throughout time. In some embodiments, the carbon footprint tracker may be a key to a green rewards program for loyalty and outside partnerships. The carbon footprint tracker may, for some embodiments, provide a connection to outside loyalty participation such as REI, Toyota (Prius), Tesla, and other businesses seeking to connect with environmentally aware users.

The carbon footprint tracker rewards program may be available in some embodiments. A rewards program may include a loyalty program that is derived from user 105's mitigated carbon footprint again by the success of single stops with multiple packages as a possible core measurement of success but certainly not the only measurement of success and mitigation.

The rewards program may include OUTSIDE relatable partnerships that could be built on related platforms inside system 200 such as green saving promotions (and others like new mothers and the like) with the likes of REI, Tesla and Toyota Prius that may be opportunity based partnerships between parties. A profile of each user 205, maintained by supervisory function 270 and accessed by device 255 or computer platform 210, may allow a user to monitor green point accumulation and redeem green rewards points as desired by user 205.

As part of supervisory function 270, each user 205 may have a customized user profile that identifies various selections and options, allows for making order and tracking orders and deliveries, and provide user 205 with notifications of delivery status. Supervisory function 270 may be integrated into various ordering and payment systems of online retailers 220 to facilitate the selection and use of system 200. That is, in some embodiments, an online retailer payment and delivery system may include an optional link to supervisory function 270 to allow it to service delivery options on behalf of user 205 and online retailer 220.

In operation of a possible embodiment, user 205 may create an account in system 200, such as by using electronic computing device 255 accessing supervisory function 270 through communications 215 to set various defaults, which may include one or more of a home, work, and/or travel delivery proxy, as well as setting a default delivery mode for each location (modes may include overnight, 2-day, and/or standard, or the like). User 205 may be able to edit these locations (including adding new locations or deleting existing locations) associated with their account.

System 200, such as function 270 communicating information to device 255, may communicate with retailers 220, organizations 260, delivery services 225 and other elements of system 200 on behalf of user 205 to obtain details regarding each order processed through system 200.

User 205, when visiting a participating online retailer, including retailers 220, will have an option to designate use of system for delivery of its order. A logistics company for the order processor (e.g., FedEx or the like) will process the order and provide function 270 with specific details (e.g., retailer/organization, logistics company, tracking ID, purchase date, arrival date, and a control to initiate a “last mile” connection for providing user with physical possession of its goods (e.g., service counter pickup, curbside transfer, home delivery at a specific time selected by user 205) which will allow delivery proxy 245 to cue the order fulfillment to have the order(s) ready. These interface functions between user 205 and system 200, implemented by function 270, may be available using platform 210, device 255, or other interface mechanism.

These interfaces may allow user 205 to visualize all orders in one consolidated screen or interface, including information regarding their arrival dates, and other delivery information as noted herein. The consolidated screen may include all retailers, all deliverers, all locations, and other user controls (e.g., activation of specific last mile connectors for each order). These interfaces may include various push, messaging, email, pager, calendar, or other notification system to inform user 205 when specific deliveries have arrived at the identified delivery proxy 245 and is available. System 200 may also may various summary information available for deliveries to allow user 205 to understand what is available where, and to enable/activate any additional services of system 200 (e.g., order or single pick from retailer hosting delivery proxy 245 holding their delivery, change last mile connector, or reroute an order when available).

These interfaces may include one or more green rewards quantification, redemption options, and green retail partner promotions. The green tracker (e.g., carbon footprint tracker) may include a collection of badges, icons, virtual collectibles, and other incentivizing elements to encourage and reward user 205 for participating in system 200.

System 200, device 255, and/or function 270 may be implemented using stored program computer systems and methods, responsive to stored instructions retrieved from a computer-readable memory, for monitoring, controlling, coordinating, calculating, measuring, and implementing the features of system 200 described and suggested herein.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the present invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A computer-implemented commercial delivery hub that offers a set of delivery agencies able to accept delivery on behalf of each purchaser of a set of purchasers, comprising one or more attributes and characteristics such as offering secure storage for deliveries, accessibility by delivery services, and purchaser access convenience selected from the group including extended hours and geographic proximity, wherein said commercial delivery hub may be associated with an existing retail or service operation that is currently frequented by a large group of prospective purchasers, said large group may include hundreds or thousands of prospective purchasers who may associate online deliveries to the frequented location responsive to a configuration and operation of a customized profile.

2. The hub of claim 1 wherein said delivery agency includes a grocery store local to a purchaser with said grocery store including at least some but may include all these attributes and characteristics, wherein the grocery store may accept delivery and secure storage of all of the deliveries on behalf of the purchaser over a wide window of time and wherein the grocery store includes many more delivery services than are available to the purchaser, providing the online retailer with a wider range of delivery options to fulfill each purchaser's order, wherein the grocery store includes business hours that are more convenient to the purchaser, such as before or after work when the purchaser is routinely away from their residence.

3. The hub of claim 1 including a coordination, on behalf of a plurality of individual distinct purchasers, a plurality of convenient delivery agencies for home, work, vacation, travel, and other locations associated with each said purchaser.

4. The hub of claim 3 wherein a purchaser having a temporary associated address for a given period, said delivery agencies may be configured to be made convenient, location and/or time, to the temporary associated address over the given period.

5. The hub of claim 1 further comprising, for the set of purchasers, a set of delivery modalities, transparent to each purchaser, to coordinate among all the delivery services available to the retailers and the delivery agency to reliably and more efficiently route deliveries to the delivery agency for all purchasers that have identified the particular delivery agency.

6. The hub of claim 5 wherein the transparent coordination may be dynamic and respond to just-in-time or other real-time delivery capacity availability for various delivery services on any given day or hour.

7. The hub of claim 1 further comprising a set of delivery goods having a delivery time with an ability of delivery services that are over or under capacity which delays an actual delivery of the set of delivery goods past the delivery time, such as with respect to an individual delivery vehicle or other capacity constraint, to coordinate alternative deliveries of the set of delivery goods by other delivery agencies having available delivery capacity to any particular hub wherein delivery of the set of delivery goods to the hub arrive no later than the delivery time.

8. The hub of claim 7 wherein said alternative deliveries include an implementation of a set of delivery efficiencies that are unavailable to the set of purchasers when the set of purchasers include an unorganized collection of purchasers.

9. A computer-implemented method for tracking a set of aggregated non-purchaser-residence deliveries for a set of individual distinct purchasers each having an independent delivery address, having an improved delivery efficiencies; and representing these set of aggregated non-purchaser-residence deliveries having the improved delivery efficiencies presented as an environmental impact metric characterizing a reduced inefficiency associated with the purchaser-user's participation and reduced delivery impact.

10. The method of claim 9 wherein the method further comprises determining, for each purchaser-user, a set of individual and aggregated environmental impact metrics which further enhances a desirability of using the set of convenient delivery agencies.

11. The method of claim 10 wherein each user may be provided with their personal environmental impact metrics in various ways to display, encourage, and/or promote a use of the set of aggregated non-purchaser-residence deliveries for the set of individual distinct purchasers.

12. The method of claim 10 further comprising converting aggregated environmental impact metrics to various rewards, incentives, points, compensation, or other value for the purchaser-user.
